(19) United States
(12) Patent Application Publication
(10) Pub. No.: US 2009/0130971 A1
(43) Pub. Date: May 21, 2009

(54) Method & apparatus for distributing files in a communications network

(75) Inventor: Christopher Piekarski, Louisville, CO (US)

Correspondence Address: ROBERT C. SCHLUER, 45 GROTON ROAD, SHIRLEY, MA, 01464, US

(73) Assignee: POLYCOM, INC.

(21) Appl. No.: 11/986,351

(22) Filed: Nov. 21, 2007

(51) Int. Cl. H04H 20/00; H04M 1/00

(52) U.S. Cl. 455/3.01; 455/556.2

(57) ABSTRACT

A wired portion of a communications network includes a server for storing update files and a plurality of access points for communicating with a plurality of wireless communication devices. A wireless portion of a communications network includes the access points and the plurality of wireless communications devices. Periodically, updated software files are available that can be downloaded to all of the wireless communication devices, via the access points. A single master wireless communication device determines that it needs to download updated software files and initiates the transfer of all new updated files to it. Subsequent to the master wireless device receiving the new updated files, it establishes an ad-hoc connection to a peer wireless communication device and if the peer wireless communication device does not have the new update software file, the master wireless communication device transfers the new updated software file to it.

### FIELD OF INVENTION

My invention relates generally to distributing software files in a communications network and specifically to downloading files stored on a server located in a wired portion of the communications network to a mobile communications device located in a wireless portion of the network from where the files can be further distributed in a cascading manner to other mobile communications devices without interaction with the wired portion of the communications network.

### BACKGROUND OF THE INVENTION

Periodically it is desirable for users of electronic devices attached to a network, a PC for instance, to download a software file from a central file storage device located on the network that can be employed by the electronic devices to upgrade, update, or enable new device functionality. The downloaded software file may be operating system software, application software, software that drives the operation of certain of the electronic devices features, or any other software that the electronic device generally employs to enable the devices functionality. Once downloaded, this software file is typically stored in the electronic devices memory where they can be accessed by a processor and used to enable the device functionality.

In a wired network, such as the Ethernet, software files which are downloaded to an electronic device are first located by the electronic device at the central file storage device and then manually commanded by user of the electronic device to be downloaded. Due to the ability of a wired network to handle the transmission of large amounts of data, many download requests can be allowed by the network in a short period of time without affecting access to the network by other electronic devices requesting network services.

As with electronic devices attached to a wired network, mobile electronic devices associated with a wireless communications network periodically need to download software files to upgrade or update existing device functionality or to provide new device functionality. Typically, a wireless communications network is associated with a wired communications network that generally, among other things, operates to receive messages from and transmit messages to the mobile electronic devices and in this case includes a central file storage device. Each of the mobile communication devices can access the central file storage device located on the wired communications network and request that certain software files be downloaded to them. Unfortunately, wireless communication networks do not have as much available bandwidth as wired networks and additionally voice or video traffic is typically given priority over data traffic, so downloading large software files over a wireless network can take extended periods of time and be problematical. For instance, if during the time a software file was being downloaded to a mobile communications device, and the mobile communications device received an incoming voice call, the device would automatically terminate the file downloading process and in the worst case have to reinitiate the downloading process from the beginning and therefore needlessly and inefficiently utilize the bandwidth that is available for transmitting data type information. For the forgoing reasons, general distributions of software files to a large number of mobile communication devices associated with a wireless communications network can take an unacceptably long period of time and make inefficient use of the available bandwidth.

It has become popular to download media files, such as music or video files, from a central storage device located on a wired network to a wireless electronic device where it can be stored for later playback. For instance, a central server located on a WAN or LAN can store music or video files that can purchased for downloading to a wireless device with access to the network such as a PDA, cellular phone, or some other mobile multimedia communications device. As described previously, downloading files from a wired network to a mobile device associated with a wireless network can be problematical from the standpoint that the process of downloading a file can take time and if interrupted, may have to start all over again. One method for solving this problem is described in the published United States patent application numbered 2006/0039304A1 entitled “Method and Apparatus for Wireless Distribution of a File Using AD-HOC Wireless Networks”. Starting in paragraph 22 and continuing in paragraph 33 of published application number 2006/0039304 A1 is described a method whereby a first wireless device establishes an ad-hoc connection to a purchase manager, which controls the distribution of media files, for the purpose of receiving a particular file. Provided the first wireless device has the right to receive the file, the first wireless device can then establish an ad-hoc connection with a file source and the requested file is downloaded from the file source to the first wireless device. Further, if a second wireless device is within range of the first wireless device and requests a file that is stored on the first wireless device, an ad-hoc connection can be established between the first and second wireless devices and the file transferred from the first to the second wireless device. Published US patent application 2006/0041943 A1 describes starting in paragraph 81 how the file distribution method operates if the purchase manager is not within range of a wireless device that is requesting a file. In this case the wireless device can establish a connection to the file manager over a cellular data network such as G3.

While the file distribution method described in the published applications 2006/0041943 and US 2006/0039304 allows the user to control which file they wish to receive thus minimizing unnecessary traffic in an ad-hoc communication environment, this method is limited by the necessity of a wireless device that is requesting a particular file to be within range of another wireless device that has the requested file stored in its memory. In fact, if the wireless device requesting a particular file never roams within range of another wireless device that has the desired file, the requesting device will never have the opportunity to receive the file. Further more, the method for distributing files described in the two applications mentioned above is not automatic, but rather manually control by the wireless device user. It is necessary for the user to manually program their wireless device in order to allow the device to receive any particular file and the user typically is responsible for initiating the file search and downloading process.

### SUMMARY OF THE INVENTION

It is desirable to be able to automatically distribute files in a wireless communication environment employing an ad-hoc communication session between wireless communication devices. Further, it is desirable for a master wireless communication device associated with a wireless communications network to automatically receive a file from a central file storage device located on a wired communications network for automatic distribution by the master wireless communication device to some or all of wireless communication devices associated with the wireless communications network.

In one embodiment of my invention, a file located in a central file storage device in a wired portion of a communications network is automatically distributed to a plurality of mobile communications devices located in a wireless portion of the communications network, the method is comprised of a first mobile communications device establishing a communication link with the central storage device in the wired portion of the communications network, determining that it needs a file located in the central file storage device and requesting that the file be transferred from the central file storage device to the first mobile communications device;

the first mobile communications device receiving and storing the requested file; the first mobile communications device establishing an ad-hoc communication link with a second mobile communications device and sending a message to the second mobile communications device that includes information indicative of its file configuration; the second mobile communications device receiving the message from the first mobile communications device and comparing the file configuration information contained in the message to file configuration information stored in the second mobile communications device, and if the file configuration information does not match the second mobile communications device requests that the first mobile communications device transmit the new files to it; and the first mobile communications device receiving the request from the second mobile communications device and sending the requested files to the second mobile communication device.

In another embodiment of my invention, a first mobile communications device establishes an ad-hoc communications session with a second mobile communications device and sends a message to the second mobile communications device that includes file configuration information; the second mobile communications device receives the message with the file configuration information and compares this information to file configuration information stored in its memory, and if the file configuration information is not the same, the second mobile communications device sends a message to the first mobile communications device requesting that all new files be sent to it; and the first mobile communications device receiving the request and sending the requested files to the second mobile communications device.

### BRIEF DESCRIPTION OF THE DRAWINGS

FIG. 1 is a high level block diagram showing the devices present on the wired and wireless portion of the communications network.

FIG. 2 is a block diagram showing the functional elements necessary to implement the invention on a mobile communications device.

FIG. 3 is a block diagram of a file server associated with the wired portion of the communications network.

FIGS. 4a-4c are a logical flow chart of an embodiment of the method of the invention.

### DETAILED DESCRIPTION OF THE INVENTION

Wireless communication devices, such as mobile phones, PDAs, or laptop computers, contain either software or firmware stored in memory that the devices use to perform the various types of functionality associated with the wireless device. Among other things, this functionality can be associated with the transmission or reception of packets of information over the wireless medium, it can implement operating system functionality, or it can be functionality associate with the operation of a display for instance. From time to time new or updated software file versions may become available that augments existing functionality or that implements new functionality on the wireless communications device. Typically, this update software is stored in a wired portion of a communications network on a central file storage device, such as a file server for instance, and is made available to the wireless communication devices associated with the wireless portion of the communications network.

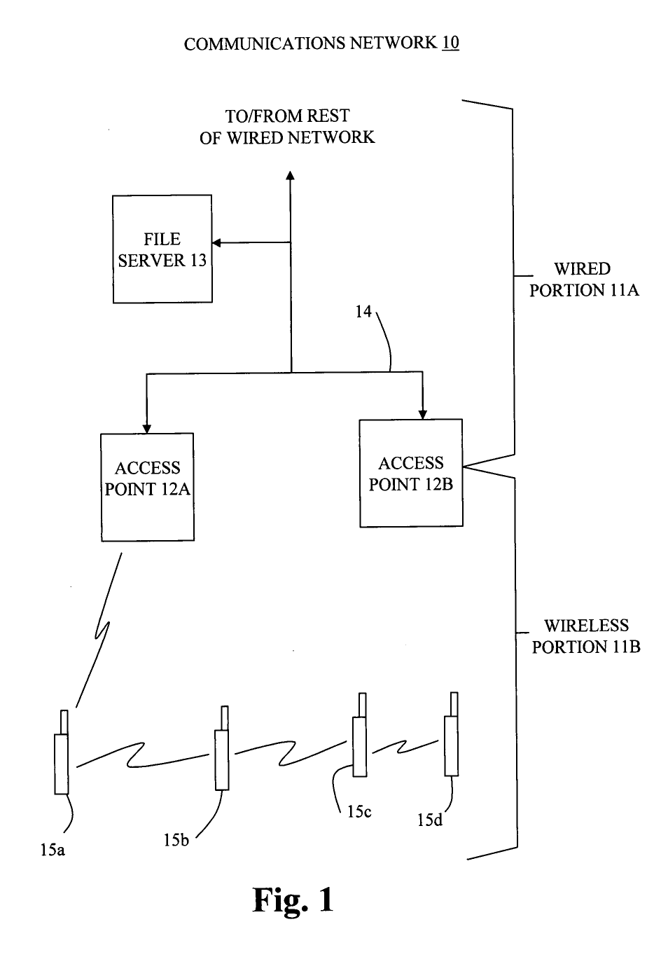

FIG. 1 is a high level diagram showing a communications network 10. The communications network 10 includes a wired portion 11a and a wireless portion 11b. The wired portion 11a can include, among other things, a central file storage device such as file server 13 and access points (AP) 12a and 12b. There can be more or fewer access points included in the network, but for the purpose of this description I will limit the number to two. The file server 13 and the assess points 12a and 12b are in communication with each other over a wired network 14 which can operate according the IEEE 802.3 standard otherwise known as the Ethernet. The wireless portion 11b of the communications network 10 can include, among other things, the two APs 12a and 12b and in this case four wireless communications devices 15a, 15b, 15c and 15d which will be hereinafter referred to at mobile phones. There may be more or fewer mobile phones associated with the wireless portion 12b of the communications network 10, but for the purpose of the description I have limited the number to four. In operation, the file server 13 functions as the central storage device for files to be distributed to other devices in the communications network 10 whether these devices are associated with the wired portion 11a or the wireless portion 11b. A network administrator typically is responsible for ensuring that the latest version of the files are stored on the file server 13 and available to other devices on the communications network 10, such as the mobile phones 15a-15d. The APs generally operate to receive packets from and transmit packets to the mobile phones 15a-15d and they may also provide some quality of service functionality as well. FIG. 1 shows a portion of the APs 15a-15d as being included in the wired portion 11a of the communications network 10 and a portion of the APs 15a-15d as being associated with the wireless portion 11b of the communications network 10. I have shown the APs 15a-15d in this manner to illustrate that they function as the interface between the wired portion 11a and the wireless portion 11b of the network. In other words, the APs 15a-15d include software that permits them to send and receive packets over the wired portion 11a of the communications network 10 and software that permits them to send and receive packets over the wireless portion 11b (802.11) of the communications network 10 and they also operate to convert the wired Ethernet packets to wireless 802.11 packets and vice versa.

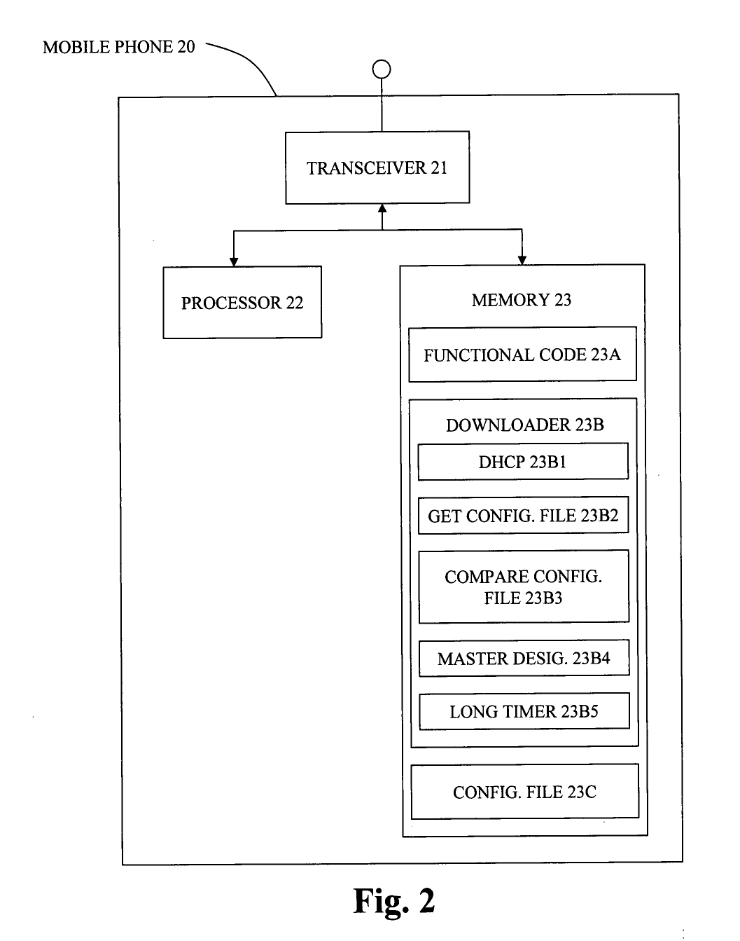

Continuing to refer to FIG. 1, and according to the preferred embodiment of my invention, at the time a mobile phone, mobile phone 15a for instance, powers-up, it will start looking for an AP to associate with. Once the mobile phone 15a associates with an AP, which could be AP 12a for instance, and establishes a communication link with AP 12a it then can send a request to the file server 13, located in the wired portion 11a of the communications network 10, for the latest software configuration information. As will be described below with reference to FIG. 2, the mobile phone 15a is pre-configured by the network administrator with the network address of the file storage device and so is able to locate the file server 13 on the communications network 10. This latest software configuration information available at the file server 13 includes, among other things, a listing of all software files available to the mobile phone 15a for downloading, the version numbers of all of the available software files, file size and CRC information. More specifically, any particular mobile phone, mobile phone 15a for instance, is typically licensed to include a particular set of software files, depending upon the desired capability of mobile phone 15a. This license information is passed to the file server 13 along with the request for a listing of the latest software configuration information available to mobile phone 15a. Assuming the file server 13 receives the request, it examines the contents of the request looking for the software license information and then responds by only sending the latest software configuration information that corresponds to the particular license allocated to the mobile phone 15a. The mobile phone 15a receives the response from the file server 13 and compares the software configuration information contained in the response to configuration information stored in the mobile phone 15a memory. If the configuration information does not match, the mobile phone 15a can then initiate a process to download the necessary new software file versions.

With further reference to FIG. 1 and in accordance with the preferred embodiment of my invention, after the mobile phone 15a receives all of the new software file versions from the file server 13, it can start sensing the wireless medium, off channel or on a channel other than the channel currently employed by AP 12 to communicate with the mobile phones 15a-15d, for other mobile phones, 15b, 15c and 15d for instance, that are within range. If mobile phone 15a discovers at least one other mobile phone, mobile phone 15b for instance, to be within range it can initiate an ad-hoc communication session off channel with mobile phone 15b and send a message to mobile phone 15b that includes the software configuration information stored on it. As described in the previous paragraph, when mobile phone 15b receives the message and compares the received software configuration information with software configuration information stored in its memory and if the configuration information does not match, mobile phone 15b can then initiate a process whereby the necessary new software files can be downloaded to it from mobile phone 15a. This process whereby one mobile phone searches for other mobile phones within range which have software files that can be updated, establishes an ad-hoc communication session with the other phones and the new software is downloaded to the other phones can be repeated until all of the mobile phones in the wireless portion 11b of the communications network 10 have updated their software files. As all of the file transfer activity during the ad-hoc communication sessions between the mobile phones occurs “off channel”, that is on a channel other than those normally used by the APs 12a or 12b to communicate with mobile phones associated with them, none of the wireless network bandwidth normally employed for voice communication is utilized for the software file downloading activity and so bandwidth is preserved for other activity such as voice traffic.

I will not describe in detail the process whereby a mobile phone searches for other mobile phones in a wireless network for the purpose of establishing an ad-hoc communications session as the method for establishing such a communications link is well know to those skilled in the art of wireless communications. But generally, a mobile phone operating in an 802.11 wireless network wishing to establish an ad-hoc communications session with another mobile phone will start the process by sensing the wireless medium on a channel or channels being used by the AP that it is currently associated with. So for instance if AP 12a in FIG. 1 is communicating with mobile phones 15a and 15b over channel 6, then mobile phone 15a can sense the medium on channel 6 looking for other phones within range. At the point that mobile phone 15a senses communication between AP 12a and mobile phone 12b for instance, it can attempt to establish an ad-hoc communication session with mobile phone 12b on a channel other than channel 6. The communication session could be established on channel 1 or 11 for instance. Generally, mobile phone 12a will employ some sort of device ID, such as the SSID, to identify other mobile phones with which it is cleared to communicate with. After mobile phone 12a has discovered mobile phone 12b, it can proceed to authenticate mobile phone 12b, generate a session key and establish an ad-hoc session with mobile phone 12b.

FIG. 2 is a diagram showing the functional blocks included in a wireless communications device 20 that are necessary for the operation of my invention. The wireless communications device 20 can be a mobile phone, a PDA or a lap top PC with wireless capability, but for the purposes of this description I will refer to the wireless communications device 20 as a mobile phone. The mobile phone 20 includes a transceiver 21 that generally functions as the interface to the wireless medium and operates to send and receive packets of information to and from the APs 15a-15c. A processor 22 generally operates in conjunction with functional code 23a stored in memory 23 to enable functionality which controls the operation of the mobile phone 20.

Continuing to refer to FIG. 2, memory 23 stores all of the software or firmware needed for the operation of the phone. In this case, this includes the functional code module 23a, a downloader module 23b and a software configuration file 23c. The functional code module 23a includes sub-modules, not shown, that function to operate the transceiver 21, to operate the audio functionality such as compressing or decompressing and encoding or decoding the raw audio information and to initiate an ad-hoc communication session with peer mobile phones. The functional code module 23a also includes application software, medium access control (MAC), user interface code and other code used for maintenance operations. The downloader module 23b is generally employed by a mobile phone to initiate the process of downloading a software file from another device associated with the communication network 10 such as file server 13 or to initiate the downloading process to another mobile phone. Also, the downloader can be used to compare software file configuration information received from another device with similar information stored on the mobile phone in which the downloader is located. The downloader module 23b can include sub-modules that enable DHCP functionality 23b1, a “get configuration file” sub-module 23b2 that is used to retrieve software file configuration information from the file server 13 and a “compare configuration file” sub-module 23b3 that is used to compare the file configuration information received from the file server 13 with a software configuration file 23c stored in the mobile phone 20 memory 23. The software configuration file 23c can include a listing of some or all the software files stored on the wireless communications device 20, their version numbers, size and CRC information. Finally, master designation sub-module 23b4 stored in memory 23 is employed by the mobile phone to designate another peer mobile phone as a master mobile phone for purposes of distributing software files from mobile phone to mobile phone over an ad-hoc communications link. Bus 24 serves as a communication path between the transceiver 21, the processor 22 and the memory 23.

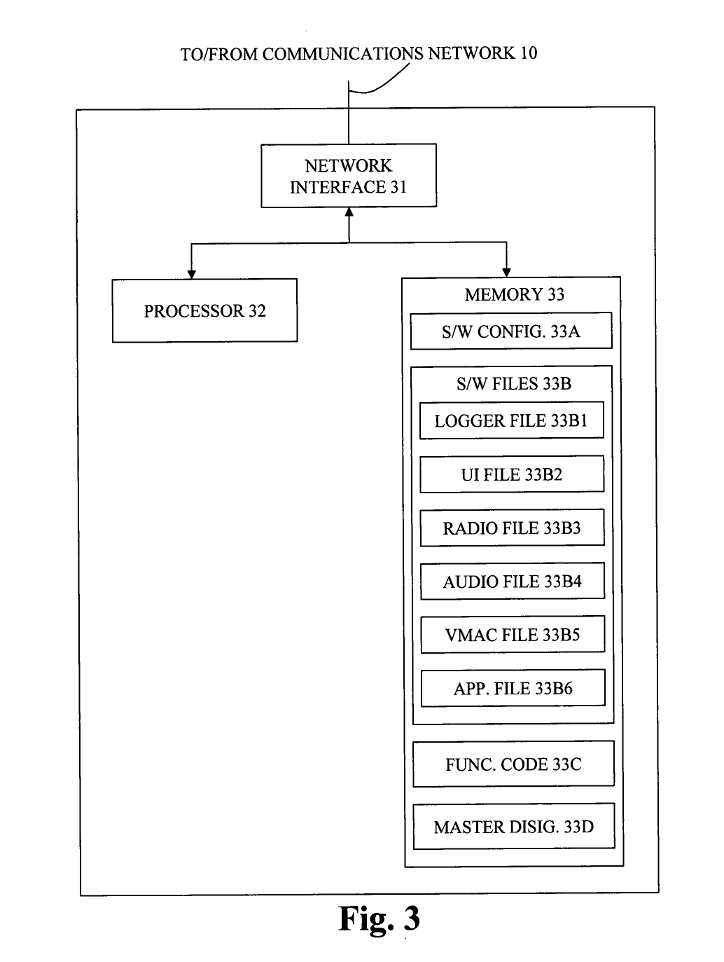

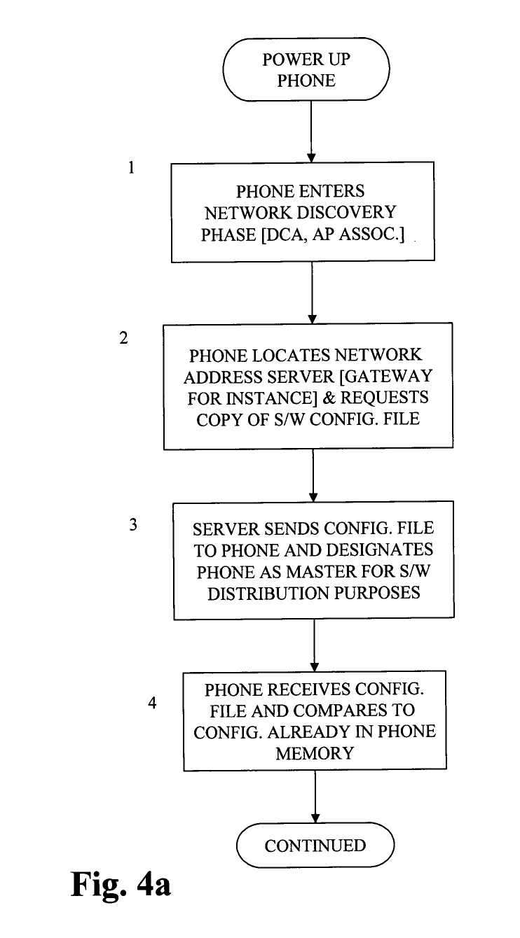

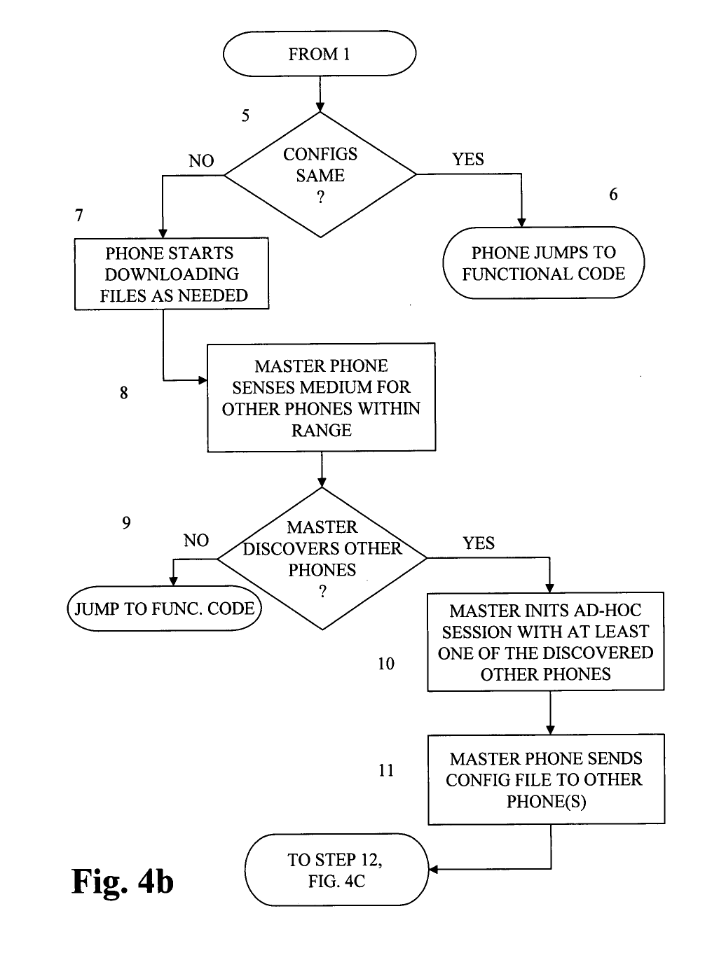

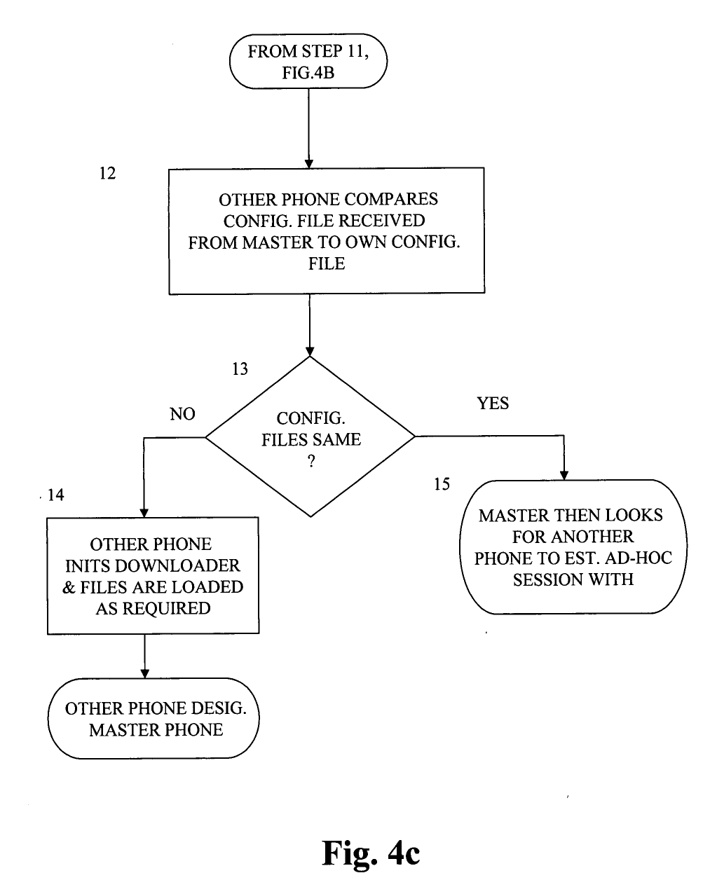

FIG. 3 is a block diagram of the functional elements of the file server that are necessary to implement the method of my invention. The file server 30 includes a network interface 31 that generally operates to convert Ethernet packets into an information format that can be used by the file server 30 and to convert messages generated by the file server 30 to the communications network 10 into the Ethernet format. The file server 30 also includes a processor 32 that generally operates in conjunction with functional code 33c stored in memory 33 to enable the various functionality provided by the file server 13 to the communications network 10. This functionality includes, among other things, processing information contained in packets that are sent to the file server 13 and performing certain actions indicated by the information contained in the received packets, such as fulfilling requests sent by mobile phones for software file configuration information. Memory 33 includes a software configuration file module 33a that includes, among other things, a listing of all the software files, their version numbers, size and CRC information. Memory 33 also includes an area for storing software files 33b each of which are complete images of the latest software file versions available for downloading by the mobile phones associated with the communications network 10. More specifically, the file storage area 33b may include a number of different software files that a mobile phone uses to perform various communications functions. The file storage area 33b can include a logger file 33b1 that can be used by a technician to debug the operation of a mobile phone in the event of an error. The file storage area 33b can include a user interface (IU) file 33b2 that is used to operate certain user interface functions such as a display or buttons that the user can press to effect certain mobile phone operation. The file storage area 33b can also include a radio file 33b3 which is used to operate a mobile phones transceiver. The file storage area 33b may also include an audio file 33b4 that is used to compress or to decompress raw audio information. I have only listed a few of the file types that can be included in the file storage area 33b, but the file storage area may contain other files that are use to effect other mobile phone functionality. And finally, memory 33 includes a master mobile phone designation module 33d which is employed to designate a mobile phone as a master for the purposes of downloading software files from the file server 13. This purpose for designating a master mobile phone and the criteria for making this designation will be described later with reference to FIG. 4.

I will now turn to a description of the preferred embodiment of my invention with reference to FIGS. 4a, 4b and 4c. It should be understood that although I describe the preferred embodiment of my invention in the context of the architecture of communications network 10 described with reference to FIG. 1, my invention is not limited to this network architecture. Also, although the preferred embodiment is implemented in an 802.11 wireless network, my invention can be practiced in other wireless network protocol as well. At the point that mobile phone 15a, for instance, powers up, in step 1 of FIG. 4a, it may attempt to locate an AP, AP 12a for instance, with which to establish a communication session. The process by which a mobile phone discovers and establishes a communication session with an access point will not be described here as this process is well know to those familiar with wireless communications technology. At the point that mobile phone 15a establishes a communication session with AP12a, and provided that mobile phone 15a is the first mobile phone to connect to the network subsequent to the software file configuration being updated, the communications network, specifically file server 13, designates mobile phone 15a as the master mobile phone or more generally the master mobile communications device. By master mobile phone I mean that mobile phone 15a is designated to be the phone that will request the latest software file configuration 33a as shown and described in FIG. 3 from the file server 30. Typically, the first mobile phone to turn on and to associate with an AP subsequent to software files stored in file server 30 being update will be designated the first master mobile phone. The functionality necessary to designate a mobile phone as a master mobile phone can be located at almost any position within the communications network 10, but in the preferred embodiment of my invention this designation functionality is located in file server 13. Preferably, and according to my strategy for limiting network bandwidth used to download file, only one mobile phone will be designated as the master mobile phone in the communications network 10. However, my invention is not limited to only designating one master mobile phone in the communications network 10 at any particular point in time, but typically and preferably a number of master mobile phones can be designated sequentially over a period of time as will be described later.

Continuing to refer to FIG. 4a, in step 2 mobile phone 15a uses the downloader 23b to send a message to, in this case, file server 13 that includes a request for the software configuration information stored in file 33a as shown in FIG. 3. As previously mentioned, file 33a includes information about the version numbers associated with software files stored on the file server 13 in the file storage area 33b also as shown in FIG. 3. In step 3 of FIG. 4a the file server 13 responds to the request message received from mobile phone 15a by sending a message to mobile phone 15a that includes the requested software file configuration information 33a. In step 4, mobile phone 15a receives the response message from the file server 13 which includes the software file configuration information 33a and employs the compare configuration file sub-module 23b3, which is described with reference to FIG. 2, to compare this information to software file configuration information 23c, as shown in FIG. 2, that is stored in its memory 23.

Referring now to FIG. 4b, in step 5, if the software file configuration information received from the file server 13 is the same as the software file configuration information stored in memory on mobile phone 15a, then mobile phone proceeds to step 6 where it jumps to the functional code 23a, shown in FIG. 2, and proceeds to operate in the normal manner. However, if the comparison in step 5 results in an indication that the two configuration files are not the same, then the process proceeds to step 7 and mobile phone 15a employs the get configuration file 23b2 to initiate the downloading of only those software files from file server 13 that have a version number different than those stored in the configuration file 23c on mobile phone 15a. Mobile phone 15a may develop a listing of all those files that it needs to download before commencing the downloading process, or it may only download a first software file from file server 13 and then loop back to step 5 to re-compare the software configuration file information, regardless, in step 7a, mobile phone 15a determines whether or not it has downloaded all of the necessary software files, and if so it proceeds to step 8, otherwise it loops back to step 7 and continues the downloading process.

Continuing to refer to FIG. 4b, in step 8 mobile phone 15a either starts to sense the wireless medium “off channel” looking for a beacon transmitted by another mobile phone, phone 15b, 15c or 15d for instance, with which it can establish an ad-hoc communication session or mobile phone 15a sends a probe “off channel” that will cause all other mobile phones within range to respond with a beacon “off channel” which indicates to mobile phone 15a that other phones are within range. As previously described, mobile phone 15a may not be authorized to establish a communication session with all other mobile phones associated with the communications network 10, but rather be limited to mobile phones included in a particular group which could be defined by the SSIP numbers of a particular group of mobile phones, which in this case are mobile phones 15a-15d. In step 9, at the point that mobile phone 15a discovers at least one other mobile phone, mobile phone 15b for instance, in step 10 it can employ the functional code 23a to try to establish an ad-hoc communication session “off channel” with this mobile phone. On the other hand, if in step 9, mobile phone 15a does not discover another mobile phone within range, the process proceeds to step 9a where mobile phone 15a jumps to the functional code 23a stored in memory 23 as shown with earlier reference to FIG. 23 and proceeds to operate in the normal manner. Returning to step 10, in the event that mobile phone 15a successfully establishes an ad-hoc communications session off channel with mobile phone 15b, the process proceeds to step 11 where mobile phone 15a utilizes downloader 23b to send a message to mobile phone 15b which includes its software configuration file information 23c.

Referring now to FIG. 4c, in step 12, mobile phone 15b receives this message from mobile phone 15a and employs the compare configuration file sub-module 23b3 to compare the software file configuration information contained in this message to software file configuration information stored in its memory, and if, in step 13, the software file configuration information does not match, the process proceeds to step 14 where mobile phone 15b employs the get configuration file sub-module 23b2 to initiate downloading the necessary software files from mobile phone 15a. At the point that all of the necessary new software files have been downloaded to mobile phone 15b, in step 15 mobile phone 15b can be designated as a master mobile phone. At this point, there may be two mobile phones designated as master mobile phones, namely mobile phone a and mobile phone b, and each of the master mobile phones can start looking for other peer mobile phones with which to establish ad-hoc sessions. Typically and preferably the functionality that provides the master mobile phone designation is located in each mobile phone associated with the communications network 10 and during the process of transferring software files from mobile phone to mobile phone over an ad-hoc communications link, the master designation sub-module 23b4 located in each mobile phone will be employed to designate the next master mobile phone; however, this master designation functionality can be located at almost any location in the communications network 10.

Continuing to refer to FIG. 4c, if for instance mobile phone 15a designates mobile phone 15b to be the master phone, then the process returns to step 8 and proceeds from there. This process loop between step 8 of FIG. 4b and step 15 of FIG. 4c will continue until all of the mobile phones, mobile phones 15a-15d in this case, associated with the communications network 10 have complete copies of the later software file versions. If, on the other hand, mobile phone 15b is the last mobile phone in the network to receive all of the latest software file versions, the process proceeds to step 16 of FIG. 4c where mobile phone 15b jumps to the functional code 23a.

Returning now to step 1 in FIG. 4a, and in one embodiment of my invention, it is possible that two mobile phones, phones 15a and 15c for instance, can both power up and enter the network discovery mode of operation at the same time. In the event, as in this case, the two mobile phones are hidden from each other, their request for the latest software file configuration information from file server 13 can collide. If such a collision happens, each of the mobile phones will invoke a back off procedure and try to send the request again at some later time. In order to prevent such a collision from happening, I have included a long timer that starts after a mobile phone is powered on. Each mobile phone associated with a wireless network can be programmed with a different long timer value and this long timer and timer value is stored in mobile phone memory 23 as referred to simply as long timer module 23b5.

Continuing to refer to step 1 in FIG. 4a, and in another embodiment of my invention, there can be a number of criteria used to determine whether or not a mobile phone can be designated as a master mobile phone. As previously mentioned, one criteria is that the mobile phone is the first phone to power on and access the communications network 10 subsequent to a software file being updated and stored in the file server 13. Another criteria can be whether or not the mobile phone is currently in call mode. It would not be desirable for a mobile phone user to experience the termination of a call simply to update the software files on their phone. Another criteria can be the remaining battery life. If the mobile phone determines that there is not sufficient remaining battery life to support the downloading of any particular software file, then the downloading process would not begin. The initiation of the downloading process can be manual and initiated by a mobile phone user or it can be automatic and independent of the actions of the user as has been described previously in the description associated with FIGS. 4a-c. Also, if during the software file downloading process, one of the mobile phones involved with the process enters into a call, the downloading process immediately terminates and can be started again from the point of termination or from the beginning. Further, the process that a mobile phone follows to discover other peer mobile phones within range can be an active process or a passive process. By this I mean that a mobile phone can send probes over the air and wait for a response from other mobile phones within range or a mobile phone can passively sense the medium for beacons transmitted by other mobile phones within range that contain SSID information for instance.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A method for distributing at least one file among a plurality of wireless communication devices comprising:
a first mobile communication device establishing an off channel ad-hoc communication session with a second mobile communication device and sending a message to the second mobile communication device that includes its file configuration information;
the second mobile communication device receiving the message from the first mobile communication device and comparing the received file configuration information contained in the message to file configuration information stored at the second mobile communication device;
if at least one file relating to the file configuration information received in the message from the first mobile communication device does not match the file configuration information stored on the second mobile communication device, the second mobile communication device requesting the first mobile communication device to send to it the at least one file that does not match;
the first mobile communication device receiving the request from the second mobile communication device and sending the requested at least one file that does not match to the second mobile communication device; and
the second mobile communication device receiving from the first mobile communication device and storing the at least one file that does not match and updating its file configuration information.

2. The method of claim 1 further comprising:
the second mobile communication device establishing an off channel ad-hoc communication session with a third mobile communication device and sending a message to the third mobile communication device that includes file configuration information;
the third mobile communications device receiving the message from the second mobile communication device and comparing the file configuration information contained in the message to file configuration information stored on the third mobile communication device;
if at least one file relating to the configuration information received in the message from the second mobile communication device does not match the file configuration information stored on the third mobile communication device, the third mobile communication device requests the second mobile communication device to send to it the at least one file that does not match,
the second mobile communication device receiving the request from the third mobile communication device and sending the requested at least one file that does not match to the third mobile communication device; and
the third mobile communication device receiving from the second mobile communication device and storing the at least one requested file that does not match and updating its file configuration information.

3. The method of claim 1 wherein the first mobile communication device is designated as a master mobile communications device.

4. The method of claim 1 wherein the mobile communication devices are one of a mobile phone, a PDA and a mobile computer.

5. The method of claim 1 wherein the file configuration is comprised of a file name, a version number and a file size.

6. A method for distributing a file from a wired portion of a communication network to a plurality of mobile communication devices associated with a wireless portion of the communication network comprising:
a first mobile communication device establishing a communication session with the wired portion of the communication network, automatically determining that it needs at least one file located on a computational device associated with the wired portion of the communication network and requesting the at least one file from the computational device;
the first mobile communication device receiving and storing the at least one file requested from the computational device associated with the wired portion of the communication network and updating its file configuration information;
the first mobile communication device establishing an off channel ad-hoc communication session with a second mobile communication device and sending a message to the second mobile communication device that includes its file configuration information;
the second mobile communication device receiving the message from the first mobile communication device and comparing the received file configuration information to file configuration information stored on the second mobile communication device,
if at least one file relating to the configuration information received from the first mobile communication device does not match the file configuration information stored on the second mobile communication device, the second mobile communication device sending a request to the first mobile communication device to send the at least one file that does not match to it;
the first mobile communication device receiving the request from the second mobile communication device and responding by sending the at least one requested file to the second mobile communication device; and
the second mobile communication device receiving and storing the at least one requested file from the first mobile communication device and updating its file configuration information.

7. The method of claim 6 further comprising:
the second mobile communication device establishing an off channel ad-hoc communication session with a third mobile communication device and sending a message to the third mobile communication device that includes its file configuration information;
the third mobile communications device receiving the message from the second mobile communication device and comparing the file configuration information to file configuration information stored on the third mobile communication device;
if at least one file relating to the file configuration information received from the second mobile communication device does not match the file configuration information stored on the third mobile communication device, the third mobile communication device requests the second mobile communication device to send the at least one file that does not match to it, and
the second mobile communication device receiving the request from the third mobile communication device and sending the at least one file that does not match to the third mobile communication device; and
the third mobile communication device receiving and storing the at least one file that does not match from the second mobile communication device and updating its file configuration information.

8. The method of claim 6 wherein the mobile communication devices are one of a mobile phone, a PDA and a mobile computer.

9. The method of claim 6 wherein the first mobile communication device is designated as a master mobile communications device.

10. The method of claim 6 wherein the wired portion of the communications network is comprised of an access point and a server.

11. The method of claim 6 wherein the files located on the server are comprised of one of a logger file, a user interface file, a radio file, an audio file, a medium access control file and an application file.

12. The method of claim 6 wherein the file configuration information is comprised of a list of file names, version numbers and file sizes.

13. The method of claim 6 wherein the step of the first mobile communication device automatically determining that it needs at least one file located on the computational device associated with the wired portion of the network is comprised of:
the first mobile communication device sending a message to the computational device requesting file configuration information;
the computational device receiving the request from the first mobile communication device and responding by sending a message that includes file configuration information to the first mobile communication device; and
the first mobile communication device receiving the message from the computational device including the file configuration information and comparing this configuration information to configuration information stored in its memory; and
the first mobile communication device determining that the configuration information received from the computational device and the configuration information stored in its memory do not match.

14. A mobile communication device comprising:
a transceiver for sending and receiving wireless messages;
a processor for controlling the operation of the mobile communication device; and
a memory for storing a file configuration information, a functional code module and a downloader module; wherein the functional code module and the downloader module operate:
to establish an ad-hoc communication session with a first peer mobile communication device;
to send a message to the first peer mobile communication device that includes file configuration information;
to respond to a request from the first peer mobile communication device to send at least one file to the first peer device; and
to send the requested at least one file to the first peer mobile communication device.

15. The mobile communication device of claim 14 is one of a mobile phone, a PDA and a mobile computer.

16. The file configuration information of claim 14 is comprised of a file name, a file version number and a file size.
